(19) United States
(12) Patent Application Publication
(10) Pub. No.: US 2013/0121605 A1
(43) Pub. Date: May 16, 2013

(54) IMAGE PROCESSING APPARATUS AND IMAGE PROCESSING METHOD

(71) Applicants: Kei Imada, Tokyo (JP); Yukie Takahashi, Tokyo (JP); Ryuji Sakai, Saitama (JP)

(72) Inventors: Kei Imada, Tokyo (JP); Yukie Takahashi, Tokyo (JP); Ryuji Sakai, Saitama (JP)

(21) Appl. No.: 13/543,114

(22) Filed: Jul. 6, 2012

(30) Foreign Application Priority Data
Nov. 14, 2011 (JP) 2011-249176

(51) Int. Cl. G06T 5/50

(52) U.S. Cl. 382/254; 382/261

(57) ABSTRACT

According to one embodiment, an image processing method includes: calculating in a unit of a display area, characteristic information indicating a characteristic included in the display area of first frame image information; searching for motion of a pixel between the first frame image information and second frame image information that is contained in the moving image information and that is posterior to the first frame image information; estimating characteristic information in the unit of the display area of the second frame image information based on the motion of the pixel and the characteristic information in the unit of the display area of the first frame image information; generating high-frequency image information in which a high-frequency component varies depending on the characteristic information in the unit of the display area of the second frame image information; and blending the high-frequency image information on the second frame image information.

### CROSS-REFERENCE TO RELATED APPLICATIONS

This application is based upon and claims the benefit of priority from Japanese Patent Application No. 2011-249176, filed on Nov. 14, 2011, the entire contents of which are incorporated herein by reference.

### FIELD

Embodiments described herein relate generally to an image processing apparatus and an image processing method.

### BACKGROUND

Conventionally, to enhance the resolution and the quality of an image, various types of image processing is performed in cameras, television receivers, and the like. One aspect of such image processing is a technology for adding a high-frequency image component such as a texture to a frame image. In the conventional technology, for example, a texture image is generated for each frame image, and the texture image is added to the frame image, whereby it is possible to improve the texture.

In the conventional technology, if an analysis is performed so as to generate a high-frequency image such as a texture for each frame image, for example, a processing load increases.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of an image processing apparatus according to a first embodiment;

FIG. 2 is an exemplary schematic diagram of a distribution calculator in the first embodiment;

FIG. 3 is an exemplary schematic diagram for explaining a probability distribution in the first embodiment;

FIG. 4 is an exemplary flowchart of a process for blending texture image data on frame image data in the image processing apparatus in the first embodiment;

FIG. 5 is an exemplary schematic diagram of a processing flow of characteristic amount calculation in a characteristic amount calculator in the first embodiment;

FIG. 6 is an exemplary schematic diagram of a timing chart of processing performed by the image processing apparatus in the first embodiment when a constant m=3 is satisfied;

FIG. 7 is an exemplary schematic diagram of motion search blocks included in a display area of the frame image data in the first embodiment;

FIG. 8 is an exemplary schematic diagram of pairs of frames on which motion search is performed by a motion search module in the first embodiment when m=3 is satisfied;

FIG. 9 is an exemplary schematic diagram of a timing chart of processing performed by an image processing apparatus according to a modification when the constant m=3 is satisfied;

FIG. 10 is an exemplary schematic diagram of a processing flow of characteristic amount estimation and reliability calculation in a characteristic amount estimating module and a reliability calculator in the first embodiment;

FIG. 11 is an exemplary schematic diagram of corresponding positions between a corresponding block (a motion search block prior to moving) and reliability blocks adjacent thereto included in reference frame image data (frame number i−m);

FIG. 12 is an exemplary flowchart of generation processing of texture image data in a generator in the first embodiment;

FIG. 13 is an exemplary block diagram of a configuration of an image processing apparatus according to a second embodiment;

FIG. 14 is an exemplary flowchart of a process for blending texture image data on frame image data in the image processing apparatus in the second embodiment;

FIG. 15 is an exemplary schematic diagram of a processing flow of reliability calculation in a characteristic amount calculator and a reliability calculator in the second embodiment; and

FIG. 16 is an exemplary schematic diagram of a processing flow of reliability estimation in a reliability estimating module in the second embodiment.

### DETAILED DESCRIPTION

In general, according to one embodiment, an image processing apparatus comprises: a characteristic calculator configured to calculate, in a unit of a predetermined display area, characteristic information indicating a characteristic included in the predetermined display area of first frame image information contained in moving image information; a search module configured to search for motion of a pixel between the first frame image information and second frame image information that is contained in the moving image information and that is posterior to the first frame image information; an estimating module configured to estimate characteristic information in the unit of the predetermined display area of the second frame image information based on the motion of the pixel searched for by the search module and the characteristic information in the unit of the predetermined display area of the first frame image information; a generator configured to generate high-frequency image information in which a high-frequency component varies depending on the characteristic information in the unit of the predetermined display area of the second frame image information; and a blending module configured to blend the high-frequency image information on the second frame image information.

### First Embodiment

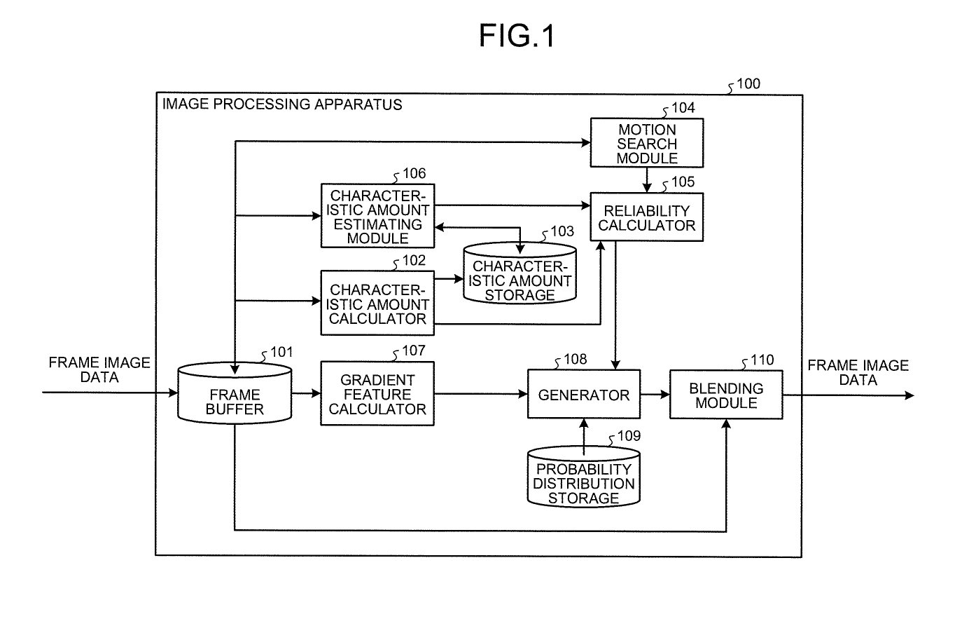

FIG. 1 is a block diagram of a configuration of an image processing apparatus according to a first embodiment. As illustrated in FIG. 1, for example, an image processing apparatus 100 comprises a frame buffer 101, a characteristic amount calculator 102, a characteristic amount storage 103, a motion search module 104, a reliability calculator 105, a characteristic amount estimating module 106, a gradient feature calculator 107, a generator 108, a probability distribution storage 109, and a blending module 110.

The image processing apparatus 100 according to the first embodiment performs processing in units of frame image data contained in moving image data in chronological order. The image processing apparatus 100 is included in a camera and a television receiver, for example. The image processing apparatus 100 performs various types of image processing on frame image data, and outputs the frame image data on which the image processing is performed.

The frame buffer 101 temporarily stores therein the frame image data thus received.

The characteristic amount calculator 102 calculates a characteristic amount indicating a characteristic included in a display area of the frame image data contained in the moving image data in units of predetermined display areas. In the first embodiment, the display size of the predetermined display area is 16×16 dots (hereinafter, also referred to as a reliability block for calculating reliability). However, the display size is not limited thereto. The characteristic amount calculated by the characteristic amount calculator 102 is represented by activity, for example. The activity is the degree of luminance fluctuation in the display area of 16×16 dots (reliability block). To calculate the activity, various methods, such as the method disclosed in Japanese Patent Application Laid-open No. 2008-310117, may be used.

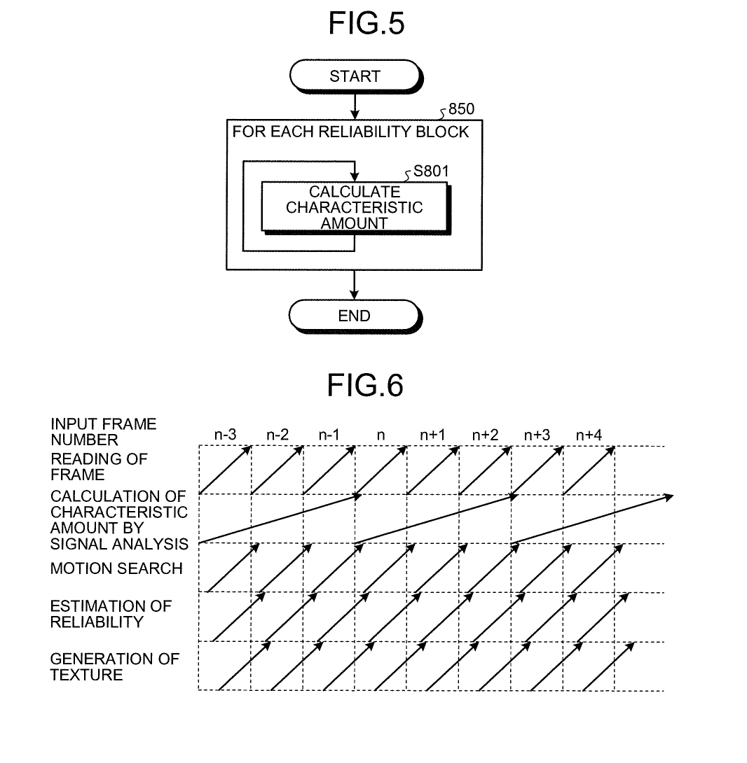

Furthermore, a motion vector calculated by performing motion search may be used as the characteristic amount. If such a motion vector is used, the characteristic amount calculator 102 may determine intensity based on the magnitude of the motion to be the characteristic amount (e.g., illustration of FIG. 5 in Japanese Patent Application Laid-open No. 2011-35450).

The characteristic amount is not limited to the activity and the motion vector, and various parameters may be used for the characteristic amount. Furthermore, the characteristic amount may be a plurality of types of parameters. If a plurality of types of parameters are used, for example, the final reliability can be determined by multiplying reliability calculated from each characteristic amount.

The image processing apparatus 100 according to the first embodiment blends texture image data on frame image data. To generate the texture image data, the characteristic amount calculator 102 calculates the characteristic amount for each reliability block (16×16 dots).

In the method disclosed in Japanese Patent Application Laid-open No. 2008-310117 and other methods, to blend a subtle texture generated to improve the texture of an image on frame image data, activity is calculated. Subsequently, if it is determined that fluctuation in the pixel value is nearly constant based on the activity, control is performed such that the blend ratio of the subtle texture increases. In the calculation of the activity, signals in a certain adjacent area need to be analyzed in the methods including the disclosed method, whereby the processing load increases. Because the calculation of the characteristic amount causes heavy processing load in this manner, the characteristic amount calculator 102 in the first embodiment calculates the characteristic amount not for all the frame image data, but for the frame image data contained in the moving image data for every predetermined image number of m.

The characteristic amount storage 103 stores therein the characteristic amount calculated by the characteristic amount calculator 102.

The characteristic amount is calculated by the characteristic amount calculator 102 for every predetermined image number of m. However, the texture image data needs to be generated for each frame image data. As a result, it is necessary to calculate the characteristic amount of all the frame image data. Therefore, in the image processing apparatus 100 according to the first embodiment, motion search is performed among a plurality of frame image data. Based on the search result and the characteristic amount calculated in one piece of frame image data, the characteristic amount of another piece of frame image data is calculated.

The motion search module 104 searches for a motion vector of a pixel between arbitrary frame image data and frame image data prior to the arbitrary frame image data among the frame image data contained in the moving image data. The motion search module 104 according to the first embodiment searches for the motion vector of the pixel in units of 8×8 dot blocks (hereinafter, also referred to as motion search blocks) obtained by dividing the reliability block (16×16 dots) in the arbitrary frame image data. The motion search module 104 according to the first embodiment calculates the motion vector in units of 8×8 dot blocks. Alternatively, the motion vector may be calculated in units of another display area size. Furthermore, the motion search may be performed with an accuracy of one-pixel units, or with a sub-pixel accuracy that is more minute than one pixel.

Based on the motion vector of the pixel among a plurality of frames searched for by the motion search module 104 and the characteristic amount of the frame image data in units of the display area, the characteristic amount estimating module 106 estimates the characteristic amount of another piece of frame image data in units of the display area. The motion search module 104 searches for the motion of the pixel between one piece of frame image data and another piece of frame image data.

In other words, the motion search module 104 performs the motion search between the frame image data, and the characteristic amount calculator 102 calculates the characteristic amount with high accuracy by a signal analysis in frame image data n. Subsequently, the characteristic amount estimating module 106 uses a motion vector between frame image data n+1 and the frame image data n to estimate the characteristic amount of the frame image data n+1 from the characteristic amount of the frame image data n. With this estimation, the characteristic amount need not be calculated for each frame image data, whereby it is possible to reduce the processing load.

The reliability calculator 105 calculate reliability for each display area (reliability block) in each frame image data based on the characteristic amount thus calculated or estimated. The reliability according to the first embodiment is the degree to which a texture component is to be added, and represents a value from 0.0 to 0.1, for example. If the characteristic amount is represented by the activity, for example, the reliability calculator 105 may perform non-linear conversion on the value of the activity, thereby converting the activity into the reliability.

The gradient feature calculator 107 calculates gradient feature data for each pixel included in the frame image data. The gradient feature data is the amount of change indicating a change in the pixel value in a predetermined display area near a pixel as a gradient for each pixel included in the frame image data. The gradient feature calculator 107 uses a differential filter to calculate the gradient feature data for each pixel included in the frame image data, for example. In the first embodiment, the gradient feature calculator 107 uses a horizontal direction differential filter or a vertical direction differential filter to calculate horizontal direction gradient feature data and vertical direction gradient feature data for each pixel. While the size of the filter used for the calculation is approximately 3×3 to 5×5, for example, the size is not limited thereto. In the description below, the horizontal direction gradient feature may be referred to as “Fx”, and the vertical direction gradient feature may be referred to as “Fy”. Furthermore, in the first embodiment, an explanation is made of the example in which the gradient feature data for each pixel is used. However, it is not limited to the gradient feature data, and any data may be used as long as the data indicates the amount of change representing a change in the pixel value in the predetermined display area.

The generator 108 calculates gradient intensity of a local gradient pattern that is a weight related to a high-frequency component of each pixel included in the frame image data based on a probability distribution indicating a distribution of relative values of gradient feature data of a high-frequency component for each pixel included in learning image information with respect to gradient feature data for each pixel included in the learning image data and on the gradient feature data (Fx, Fy) calculated for each pixel included in the frame image data. The learning image data according to the first embodiment has the same resolution (size of the display area) as that of the frame image data.

The local gradient pattern according to the first embodiment is a predetermined image pattern indicating a pattern of a change in a predetermined pixel value (e.g., a luminance value). The gradient intensity is a weight that is related to a high-frequency component for each pixel included in the frame image data and that is calculated based on the gradient feature. The gradient intensity is used for generating the high-frequency component of the frame image data.

The generator 108 then weights the local gradient pattern with the gradient intensity, and generates texture image data indicating the high-frequency component for the frame image data based on the reliability calculated for each display area. The local gradient pattern and the gradient intensity will be described later in detail.

At this time, by generating the texture image data based on the reliability, the generator 108 according to the first embodiment can generate the texture image data in which the texture component varies depending on the characteristic amount of the frame image date in units of the reliability block (16×16 dots).

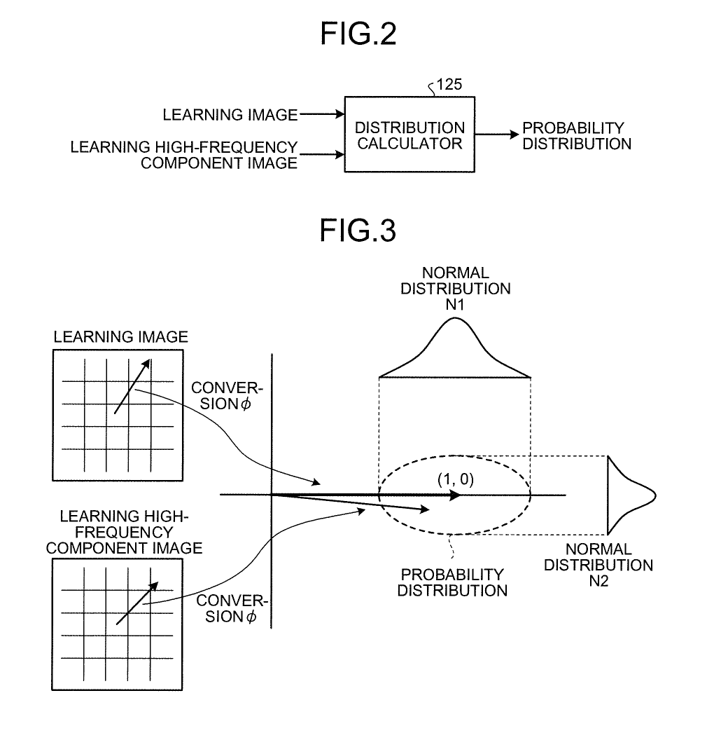

The probability distribution according to the first embodiment is the distribution of the relative values described above, and is distribution of the relative angles and relative magnitudes of the gradient of pixels in leaning high-frequency component image data with respect to the gradient of each pixel in the learning image data. The probability distribution will now be described. FIG. 2 is a schematic diagram of a distribution calculator 125 in the first embodiment. The distribution calculator 125 may be provided inside of the image processing apparatus 100. Alternatively, the distribution calculator 125 may be provided outside of the image processing apparatus 100, and the probability distribution calculated by the distribution calculator 125 may be stored in the image processing apparatus 100.

As illustrated in FIG. 2, the distribution calculator 125 receives the learning image data and the leaning high-frequency component image data, and outputs probability distribution data. The probability distribution data thus output is stored in the probability distribution storage 109.

FIG. 3 is a schematic diagram for explaining the probability distribution in the first embodiment. The distribution calculator 125 calculates the gradient in pixels located at the same position in the learning image data and the leaning high-frequency component image data. The differential filter used for the gradient calculation is the same as that used in the gradient feature calculator 107. The learning high-frequency component image data is image data of the high-frequency component in the learning image data. The image quality of the learning image data may deteriorate similarly to the frame image data.

As illustrated in FIG. 3, the distribution calculator 125 calculates the probability distribution on a two-dimensional plane area. The x-axis of the plane area is the gradient direction of each pixel in the learning image data, and the y-axis is a direction perpendicular to the gradient direction. The distribution calculator 125 converts the gradient of each pixel included in the learning image data into a vector of (1, 0). A transformation matrix that converts the gradient of an arbitrary pixel into a vector of (1, 0) is referred to as “conversion φ”. The distribution calculator 125 then converts the gradient of the pixel in the learning high-frequency component image data located at the same position as that of the arbitrary pixel by using the conversion φ. As a result, it is possible to obtain the vector of the gradient of each pixel in the learning high-frequency component image data relatively converted based on the gradient of each pixel in the learning image data.

The distribution calculator 125 calculates the vector of the gradient of the high-frequency component for each pixel as described above, thereby calculating a probability distribution surrounded by the dashed line in FIG. 3 indicating fluctuation in the gradient of the learning high-frequency component image data. As illustrated in FIG. 3, the probability distribution is represented by two-dimensional normal distribution of “normal distribution N1” and “normal distribution N2”.

In the image processing apparatus 100 according to the first embodiment, the probability distribution calculated in the processing described above is stored in the probability distribution storage 109 in advance.

The generator 108 then uses the probability distribution and the gradient feature data to calculate the gradient intensity. The average of the “normal distribution N1” is “μ1”, and standard deviation thereof is “σ1”. The average of the “normal distribution N2” is “μ2”, and standard deviation thereof is “σ2”. The generator 108 acquires a random variable “α” from the “normal distribution N1”, and acquires a random variable “β” from the “normal distribution N2”. The generator 108 then calculates the gradient intensity of the high-frequency component by substituting the random variable “a”, the random variable “β”, and the gradient feature data (Fx, Fy) into Equation (1):

fx=αFx+βFy, fy=αFy−βFx (1)

where “fx” represents the horizontal direction gradient intensity, and “fy” represents the vertical direction gradient intensity.

Subsequently, based on the gradient intensity of the high-frequency component (horizontal direction: fx, and vertical direction: fy) and the local gradient patterns (horizontal direction: Gx, and vertical direction: Gy), the generator 108 generates a high-frequency component for the input image data. “Gx” and “Gy” are predetermined image patterns indicating patterns of a change in a predetermined pixel value. In the first embodiment, “Gx” and “Gy” are base patterns having the same luminance change as that of the filter used for the calculation of the gradient of the learning high-frequency component image performed by the distribution calculator 125.

In other words, the generator 108 calculates a high-frequency component “T” for each pixel included in the frame image data by substituting the gradient intensity (horizontal direction: fx, and vertical direction: fy) and the local gradient patterns (horizontal direction: Gx, and vertical direction: Gy) into Equation (2):

T=fx·Gx+fy·Gy (2)

Subsequently, the generator 108 changes the high-frequency component “T” based on the reliability. If reliability α represents a value from 0.0 to 1.0, for example, the generator 108 may perform processing using Equation (3):

T′=αT (3)

As a result, it is possible to vary the high-frequency component to be added to the frame image data in accordance with the reliability, that is, the characteristic amount.

In the first embodiment, high-frequency component image data composed of the high-frequency component “T′” calculated for each pixel by the generator 108 is texture image data. In the first embodiment, the display area of the texture image data has the same size as that of the frame image data.

Subsequently, the blending module 110 blends the texture image data corresponding to the frame image data for each frame image data. As a result, it is possible to improve the texture, thereby achieving high image quality.

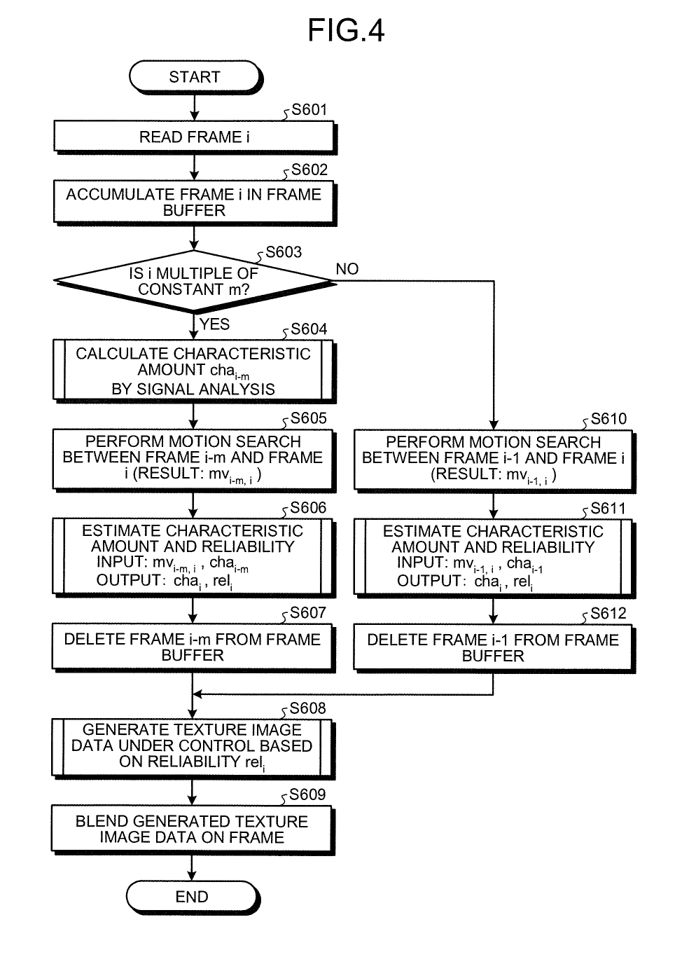

An explanation will be made of processing for blending the texture image data on the frame image data in the image processing apparatus 100 according to the first embodiment. FIG. 4 is a flowchart of a process of the processing described above in the image processing apparatus 100 in first the embodiment.

The image processing apparatus 100 reads frame image data (frame number i) from outside thereof (S601). i is an arbitrary integer uniquely assigned to each frame image data. The image processing apparatus 100 accumulates the frame image data (frame number i) in the frame buffer 101 (S602).

Subsequently, the characteristic amount calculator 102 determines whether the frame number i is a multiple of a constant m (S603). In other words, in the present processing flow, the characteristic amount is calculated only when the frame number i is a multiple of the constant m.

If the characteristic amount calculator 102 determines that the frame number i is a multiple of the constant m (Yes at S603), calculation of a characteristic amount chaᵢ₋ₘ that is started before a time period of m number of frames by a signal analysis for each reliability block performed by the characteristic amount calculator 102 is completed (S604). The characteristic amount chaᵢ₋ₘ thus calculated is stored in the characteristic amount storage 103. The processing for calculating the characteristic amount according to the first embodiment is performed in a divided manner in a time period for inputting a plurality of frames equal to or less than m number of frames as a separate thread. As a result, it is possible to smooth the processing load in each frame section.

FIG. 5 is a schematic diagram of a processing flow of the characteristic amount calculation in the characteristic amount calculator 102 in the first embodiment. As illustrated in FIG. 5, the characteristic amount calculator 102 according to the first embodiment calculates the characteristic amount for each reliability block included in the frame image data (loop processing 850) (S801). The reliability block according to the first embodiment is a block serving as a unit of calculation of the reliability, and is a block obtained by dividing the frame image data into 16×16 dots.

FIG. 6 is a schematic diagram of a timing chart of processing performed by the image processing apparatus 100 in the first embodiment when the constant m=3 is satisfied. As illustrated in FIG. 6, processing is performed in order of reading of a frame image, calculation of the characteristic amount by a signal analysis, motion search, prediction of the reliability, and generation of a texture.

As illustrated in FIG. 6, when the constant m=3 is satisfied, the characteristic amount calculator 102 only needs to calculate the characteristic amount by a signal analysis in a time period for inputting three frames. As illustrated in FIG. 6, by calculating the characteristic amount only once every three frames, and dividing the calculation of the characteristic amount performed once in the time period for inputting the three frames, it is possible to divide and reduce the processing load.

In the example illustrated in FIG. 6, for each processing in each frame section, an arrow extending upward indicates progress of the processing in the frame (usually, raster order from the upper left of an image). In the image processing apparatus 100 according to the first embodiment, the processing illustrated in the upper section in FIG. 6 is started first. After the start of the processing, generation of information required for subsequent processing that uses the result of the processing serves as a trigger to start the subsequent processing. In the motion search, for example, the fact that the pixel value in an area to be searched is read by reading of the frame serves as a trigger to start the processing. As a result, as illustrated in FIG. 6, delay occurs as the processing proceeds to the lower section. Even if delay occurs in this manner, however, the delay does not affect the processing of the subsequent frame. Therefore, it is possible to perform the processing in a parallel manner in units of the frames. Hereinafter, an explanation will be made on the assumption of such processing unless otherwise noted.

Subsequently, the motion search module 104 performs motion search between frame image data (frame number i−m) and the frame image data (frame number i) stored in the frame buffer 101 (S605). In the motion search performed by the motion search module 104, corresponding block in the frame image data (frame number i−m) is calculated for each motion search bock of 8×8 dots in the frame image data (frame number i). The result thereof is represented as a motion vector mv_{i-m, i}.

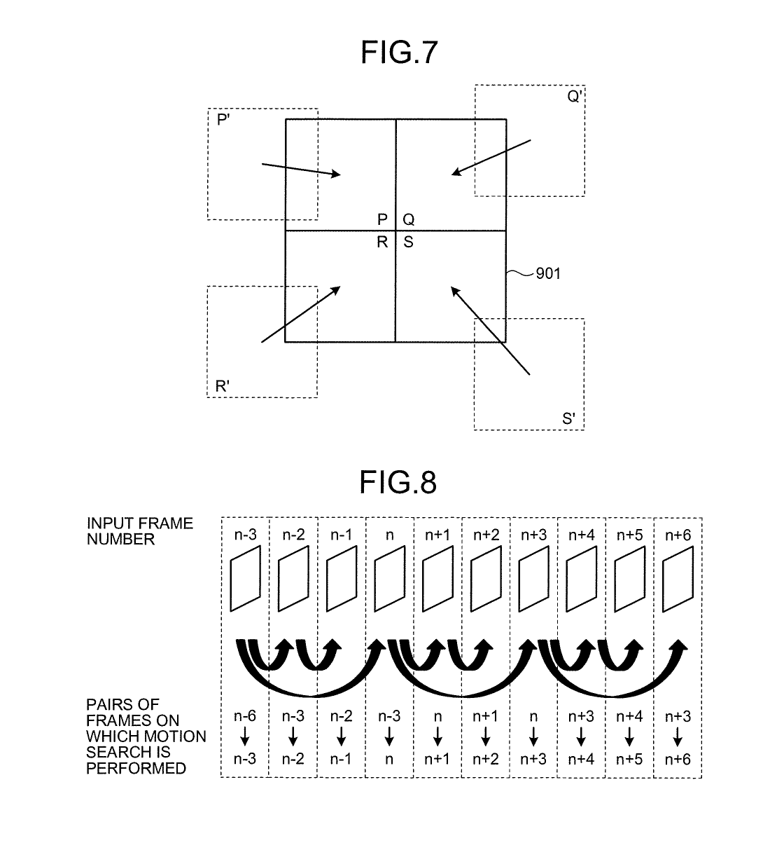

FIG. 7 is a schematic diagram of an example of motion search blocks included in a display area of the frame image data in the first embodiment. In the example illustrated in FIG. 7, a reliability block 901 (16×16 dots) includes motion search blocks (8×8 dots) P, Q, R, and S. As described above, in the first embodiment, one reliability block includes four motion search blocks.

Based on a pair of frame image data (e.g., frame image data of the frame number i and the frame number i−m), the motion search module 104 searches for the positions of corresponding blocks P′, Q′, R′, and S′ having a similar pixel pattern as that of the motion search blocks P, Q, R, and S, respectively. In the first embodiment, the motion search blocks P, Q, R, and S are included in the frame image data (frame number i (i is a multiple of m)), and the corresponding blocks P′, Q′, R′, and S′ are included in the frame image data (frame number i−m). An arrow vector illustrated in FIG. 7 indicates a motion vector of each motion search block searched for by the motion search module 104. Even if the motion search blocks and the reliability block are out of alignment, it is possible to deal with the misalignment by performing proper weighting on the positions corresponding to each other, for example.

If i is smaller than m, the frame image data (frame number i−m) is yet to be buffered in the frame buffer 101. Therefore, the subsequent processing is skipped, and the texture image data may be generated considering that no characteristic amount is obtained. Alternatively, the texture image data may be generated by calculating the characteristic amount using the own frame image data as reference frame image data.

FIG. 8 is a schematic diagram of pairs of frames on which motion search is performed by the motion search module 104 when m=3 is satisfied. As illustrated in FIG. 8, if the frame number i is a multiple of 3, the motion search module 104 performs motion search between the frame image data of the frame number i and frame image data three data prior thereto (frame number i−3) through the processing at S605 in FIG. 4.

In other words, frame image data of a frame number n−3 is paired with frame image data of a frame number n−6, frame image data of a frame number n is paired with the frame image data of the frame number n−3, and frame image data of a frame number n+3 is paired with the frame image data of the frame number n.

This is because processing time for 3 frames is required for the characteristic amount calculator 102 to calculate the characteristic amount as illustrated in FIG. 6. In other words, in the image processing apparatus 100 according to the first embodiment, the motion search module 104 performs motion search between the frame image data (frame number n−3) obtained just after the characteristic amount is calculated and the frame image data (frame number n), making it possible to estimate the characteristic amount and the reliability included in the frame image data (frame number n).

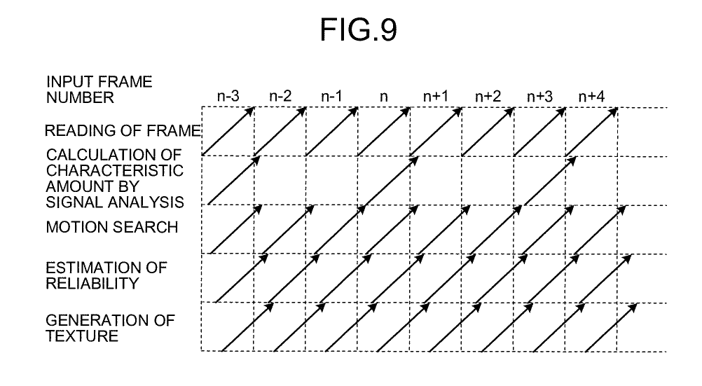

If motion search is performed between the frame image data of the frame number i and the frame image data m pieces of data prior thereto, the motion search may possibly be less-accurate because the frame image data m pieces of data prior thereto is used. To prevent this, the calculation of the characteristic amount by a signal analysis of the characteristic amount calculator 102 may be performed in a time period of one frame. FIG. 9 is a schematic diagram of a timing chart of processing performed by an image processing apparatus according to a modification when the constant m=3 is satisfied. In the example illustrated in FIG. 9, the calculation of the characteristic amount by a signal analysis is completed in a time period of one frame. If the calculation of the characteristic amount is performed in one frame in this manner, the processing load in the frame of a frame number that is a multiple of m increases temporarily, whereas the processing loads in other frames can expect to be reduced. If other processing is performed when the processing loads are reduced in this manner, it is also possible to use computer resource effectively.

In the example illustrated in FIG. 9, because the calculation of the characteristic amount is completed in a time period of one frame, the frame image data can be used for performing motion search between the frame image data and frame image data subsequent thereto. As a result, it is possible to improve the accuracy.

Referring back to FIG. 4, the characteristic amount estimating module 106 and the motion search module 104 respectively estimates a characteristic amount chaᵢ and calculates reliability relᵢ based on the characteristic amount chaᵢ₋ₘ calculated at S604 and the motion vector mv_{i-m, i} calculated at S605 (S606). It is assumed that the characteristic amount chaᵢ₋ₘ in the frame i−m has already been calculated at the time point of the processing at S606.

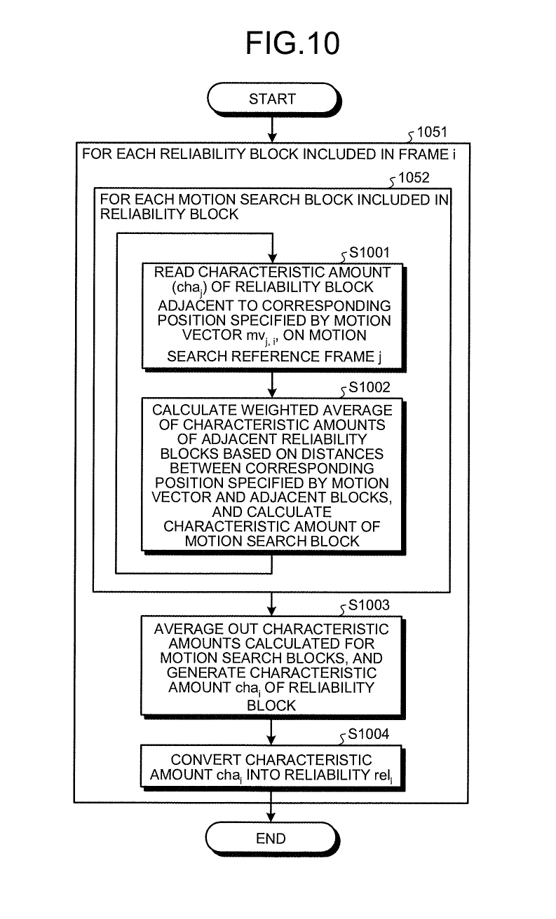

FIG. 10 is a schematic diagram of a processing flow of characteristic amount estimation and reliability calculation in the characteristic amount estimating module 106 and the reliability calculator 105 in the first embodiment. As illustrated in FIG. 10, the reliability calculator 105 according to the first embodiment repeats the loop processing 1051 for each reliability block (16×16 dots) included in the frame image data of the frame number i.

At this time, the characteristic amount estimating module 106 repeats the loop processing 1052 of S1001 and S1002 for each of all the motion search blocks (8×8 dots) included in the reliability block.

In other words, the characteristic amount estimating module 106 reads a characteristic amount chaⱼ of a reliability block adjacent to a corresponding block (block prior to moving) specified by a motion vector mv_{j, i} on a motion search reference frame j for each motion search block (S1001). In the case of S606 in FIG. 4, j denotes i−m. By contrast, if the processing illustrated in FIG. 10 is performed at S611 in FIG. 4, j denotes i−1.

In the example illustrated in FIG. 7, to estimate the characteristic amount chaⱼ of the motion search block P, the characteristic amount estimating module 106 reads the characteristic amount chaᵢ₋ₘ of a reliability block adjacent to the corresponding block P′ whose position is corresponding to the position of the motion search block P prior to moving from the characteristic amount storage 103.

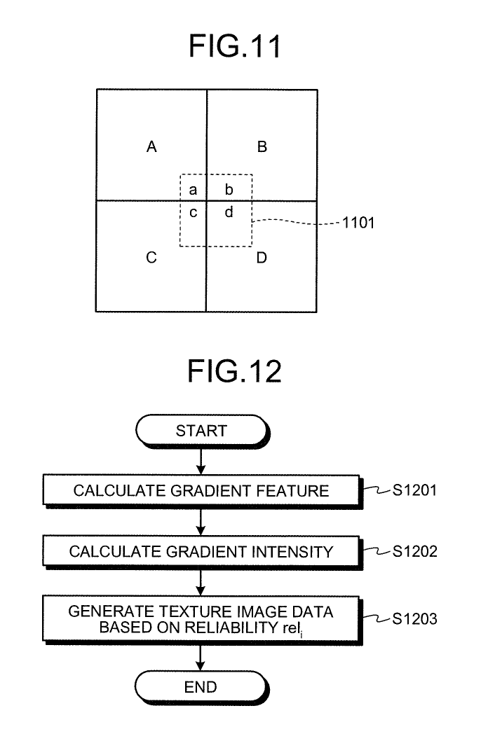

FIG. 11 is a schematic diagram of corresponding positions between a corresponding block (a motion search block prior to moving) and reliability blocks adjacent thereto included in reference frame image data (frame number i−m). In the example illustrated in FIG. 11, the characteristic amount estimating module 106 reads characteristic amounts cha_{i-m, a}, cha_{i-m, b}, cha_{i-m, c}, and cha_{i-m, d} of reliability blocks A, B, C, and D, respectively, at least a part of which overlaps with a corresponding block 1101 as the reliability blocks adjacent to the corresponding block 1101.

Subsequently, based on the distances between the corresponding block (e.g., the corresponding block P′) whose position is corresponding to the position of the motion search block (e.g., the motion search block P) before the motion vector moves and the reliability blocks adjacent thereto, the characteristic amount estimating module 106 calculates the weighted average of the characteristic amounts of the reliability blocks adjacent to the corresponding block, thereby calculating the characteristic amount of the motion search vector (motion search block P) (S1002).

In the example illustrated in FIG. 11, based on the distance between the corresponding block P′ and each of the reliability blocks, the characteristic amount estimating module 106 uses overlapping areas (a, b, c, and d) as weights to calculate the weighted average of the characteristic amounts. The reliability of the reliability blocks A, B, C, and D is cha_{i-m, a}, cha_{i-m, b}, cha_{i-m, c}, and cha_{i-m, d}, respectively. In this case, the characteristic amount estimating module 106 calculates the characteristic amount of the corresponding block P′ by Equation (4):

cha_{i-m, P′}=(a*cha_{i-m, a}+b*cha_{i-m, b}+c*cha_{i-m, c}+d*cha_{i-m, d})/(a+b+c+d) (4)

The characteristic amount estimating module 106 then estimates the characteristic amount cha_{i-m, P′} of the corresponding block P′ thus calculated to be the characteristic amount of the motion search block P, which is the position posterior to moving.

Referring back to FIG. 10, the characteristic amount estimating module 106 averages out the characteristic amounts calculated for the motion search blocks included in the reliability block, thereby generating the characteristic amount chaᵢ of the reliability block (S1003).

Subsequently, the reliability calculator 105 converts the characteristic amount chaᵢ into the reliability relᵢ (S1004). To convert the characteristic amount chaᵢ into the reliability relᵢ, various types of methods can be employed. If the activity is used as the characteristic amount as disclosed in Japanese Patent Application Laid-open No. 2008-310117, for example, the reliability calculator 105 may perform the conversion as follows: the smaller the characteristic amount chaᵢ is, the closer to 1.0 the reliability relᵢ is; and the larger the characteristic amount chaᵢ is, the closer to 0.0 the reliability relᵢ is.

In the process described above, the reliability calculator 105 calculates the reliability relᵢ for each of all the reliability blocks included in the frame image data. After all the processing illustrated in FIG. 10 is completed, the characteristic amount chaᵢ and the reliability relᵢ of each reliability block are output.

Referring back to FIG. 4, the characteristic amount estimating module 106 deletes the frame image data of the frame number i−m from the frame buffer 101 (S607).

By contrast, if the characteristic amount calculator 102 determines that the frame number i is not a multiple of the constant m at S603 (No at S603), the motion search module 104 performs motion search between the frame image data of the frame number i−1 and the frame image data of the frame number i stored in the frame buffer 101 (S610). The process of the motion search is the same as that of S605 except that the number of the reference frame is i−1.

The characteristic amount estimating module 106 and the motion search module 104 function to estimate the characteristic amount chaᵢ and calculate the reliability relᵢ from the characteristic amount chaᵢ₋₁ stored in the characteristic amount storage 103 and the motion vector mv_{i-1, i} calculated at S610 (S611). The characteristic amount chaᵢ thus calculated is stored in the characteristic amount storage 103. In other words, based on the pairs of the frame image data illustrated in FIG. 8, the characteristic amount estimating module 106 estimates the characteristic amount chaᵢ of the frame image data (frame number i) from the characteristic amount chaᵢ₋₁ of the frame image data one data prior thereto (frame number i−1). If i is smaller than m, the characteristic amount chaᵢ₋₁ of the frame image data of the frame number i−1 is yet to be calculated at this point. Therefore, generation of texture image data and blend of the texture image data thus generated on the frame image data are performed considering that no reliability relᵢ is obtained.

Subsequently, the characteristic amount estimating module 106 deletes the frame image data of the frame number i−1 from the frame buffer 101 (S612).

After S607 and S612, the generator 108 generates texture image data under control based on the reliability relᵢ (S608).

An explanation will be made of the generation processing of the texture image data in the generator 108 according to the first embodiment. FIG. 12 is a flowchart of the processing described above in the generator 108 in the embodiment.

The gradient feature calculator 107 uses the horizontal direction differential filter or the vertical direction differential filter to calculate a horizontal direction gradient feature and a vertical direction gradient feature for each pixel in the frame image data (S1201).

Subsequently, the generator 108 calculates the gradient intensity of each pixel in the frame image data based on a random variable derived from a probability distribution indicating a distribution of vectors, each of which is relative magnitude and a relative angle of the gradient feature of each pixel included in a high-frequency component of learning image information with respect to the gradient feature of each pixel included in the learning image information and on the gradient feature calculated by the gradient feature calculator 107 (S1202).

The generator 108 then generates texture image data indicating a high-frequency component for the frame image data based on the gradient intensity related to the high-frequency component for each pixel of the frame image data, the local gradient pattern, and the reliability calculated for each reliability block in the frame image data (S1203).

In the process described above, the texture image data in which the texture component to be added varies depending on the reliability of each reliability block is generated.

Referring back to FIG. 4, the blending module 110 blends the texture image data thus generated on the frame image data (S609).

In the process described above, the texture image data in which the texture component to be added varies for each reliability block depending on the characteristic amount of each reliability block can be generated and added to the frame image data. Therefore, it is possible to improve the texture.

### Second Embodiment

In the image processing apparatus according to the first embodiment, an explanation has been made of the example in which, to reduce the processing load, the characteristic amount calculated for every predetermined number of frame images is stored and used for calculating the reliability for each frame image data. In the first embodiment, the parameter stored to reduce the processing load is not limited to the characteristic amount. In an image processing apparatus according to a second embodiment, an example will be explained in which the reliability is stored.

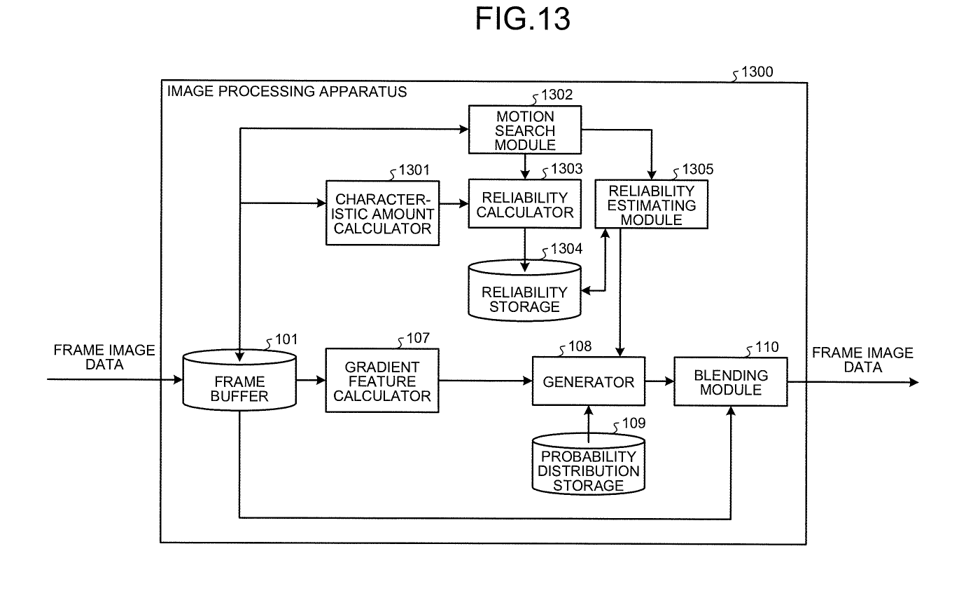

FIG. 13 is a block diagram of a configuration of the image processing apparatus according to the second embodiment. As illustrated in FIG. 13, for example, an image processing apparatus 1300 comprises a frame buffer 101, a characteristic amount calculator 1301, a motion search module 1302, a reliability calculator 1303, a reliability storage 1304, a reliability estimating module 1305, a gradient feature calculator 107, a generator 108, a probability distribution storage 109, and a blending module 110. In the description below, components similar to those of the first embodiment are denoted by similar reference numerals, and explanations thereof will be omitted.

The characteristic amount calculator 1301 calculates the characteristic amount in units of reliability blocks for every predetermined number of pieces of frame image data.

Every time the frame image data is read, the motion search module 1302 searches for a motion vector of a pixel among a plurality of pieces of frame image data. The motion search module 1302 according to the second embodiment searches for the motion vector for each motion search block obtained by dividing a reliability block in the same manner as in the first embodiment.

The reliability calculator 1303 calculates reliability for each reliability block of each frame image data based on the characteristic amount calculated by the characteristic amount calculator 1301.

The reliability storage 1304 stores therein the reliability calculated by the reliability calculator 1303.

Based on the reliability of each reliability block of arbitrary frame image data stored in the reliability storage 1304 and the motion vector searched for by the motion search module 1302, the reliability estimating module 1305 estimates the reliability for each reliability block in the frame image data read subsequently to the arbitrary frame image data.

The generator 108 uses the reliability estimated by the reliability estimating module 1305 to generate texture image data for each frame image data.

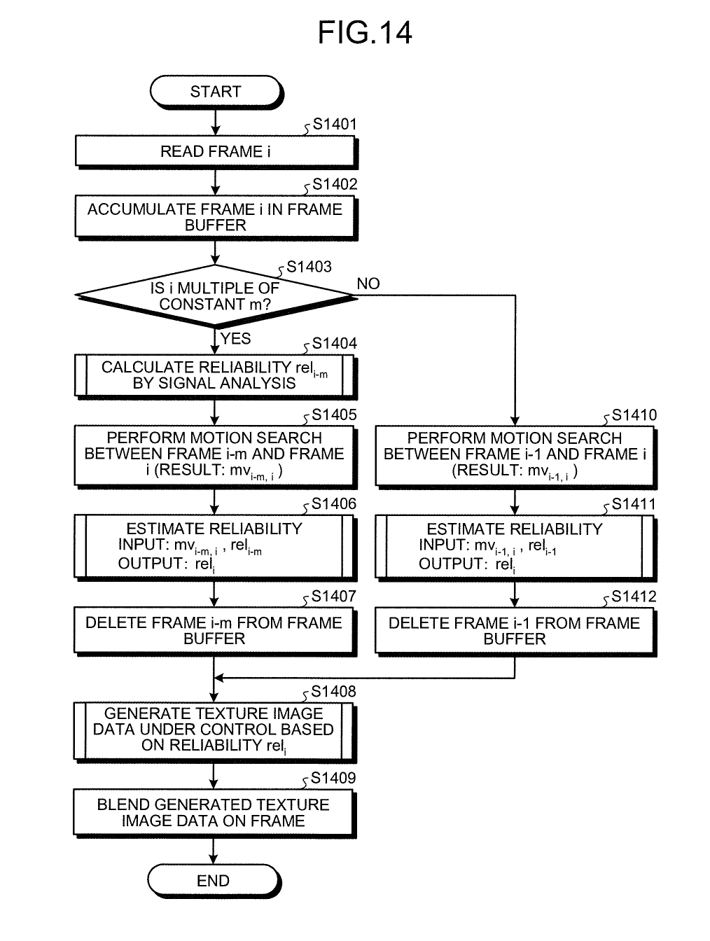

An explanation will be made of processing for blending the texture image data on the frame image data in the image processing apparatus 1300 according to the second embodiment. FIG. 14 is a flowchart of a process of the processing described above in the image processing apparatus 1300 in the second embodiment.

In the same manner as that at S601 to S603 in the first embodiment illustrated in FIG. 4, the characteristic amount calculator 1301 determines whether a frame number i is a multiple of a constant m (S1403). In other words, in the second embodiment, the characteristic amount is calculated only when the frame number i is a multiple of the constant m.

If the characteristic amount calculator 1301 determines that the frame number i is a multiple of the constant m (Yes at S1403), a characteristic amount chaᵢ₋ₘ is calculated by the characteristic amount calculator 1301, and reliability relᵢ₋ₘ is calculated by the reliability calculator 1303 (S1404).

The reliability relᵢ₋ₘ thus calculated is stored in the reliability storage 1304. The processing for calculating the characteristic amount chaᵢ₋ₘ is performed in a divided manner in a time period for inputting a plurality of frames equal to or less than m number of frames as a separate thread. As a result, it is possible to smooth the processing load in each frame section.

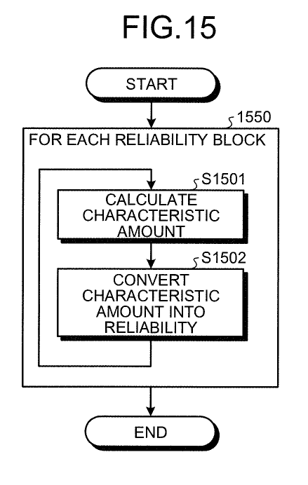

FIG. 15 is a schematic diagram of a processing flow of reliability calculation in the characteristic amount calculator 1301 and the reliability calculator 1303 in the second embodiment.

As illustrated in FIG. 15, the characteristic amount calculator 1301 according to the second embodiment calculates the characteristic amount chaᵢ₋ₘ for each reliability block included in the frame image data (loop processing 1550) (S1501). In the same manner as in the first embodiment, before reliability relᵢ of the frame image data of the frame number i is calculated, calculation of the characteristic amount chaᵢ₋ₘ of each reliability block in the frame image data m number of frames prior thereto (frame number i−m) is completed.

Subsequently, the reliability calculator 1303 converts the characteristic amount chaᵢ thus calculated into the reliability relᵢ₋ₘ (S1502).

By performing the process described above, the reliability relᵢ₋ₘ of the frame image data of the frame number i−m is calculated.

Referring back to FIG. 14, the motion search module 1302 performs motion search between the frame image data of the frame number i−m and the frame image data of the frame number i stored in the frame buffer 101 (S1405).

Subsequently, the reliability estimating module 1305 estimates the reliability relᵢ based on the reliability relᵢ₋ₘ calculated at S1404 and a motion vector mv_{i-m, i} calculated at S1405 (S1406).

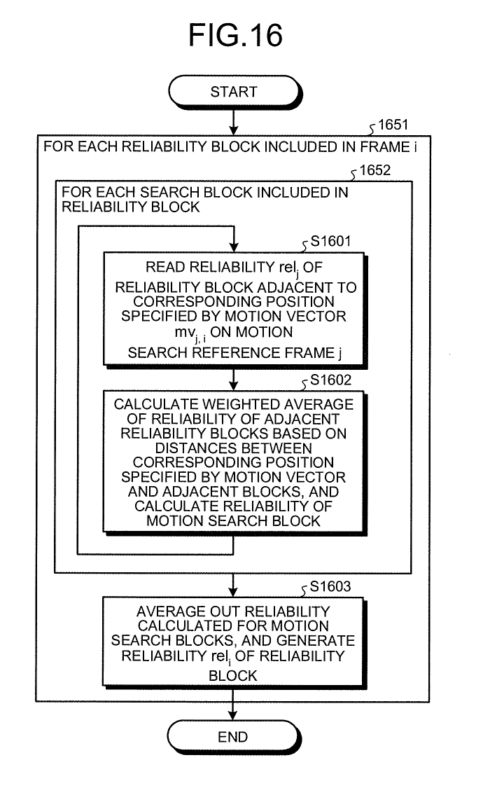

FIG. 16 is a schematic diagram of a processing flow of reliability estimation in the reliability estimating module 1305 in the second embodiment. As illustrated in FIG. 16, the reliability estimating module 1305 according to the second embodiment repeats the loop processing 1651 for each reliability block included in the frame image data of the frame number i.

Furthermore, the reliability estimating module 1305 repeats the loop processing 1652 of S1601 and S1602 for each of all the motion search blocks included in the reliability block.

In other words, the reliability estimating module 1305 reads reliability relⱼ of a reliability block adjacent to a corresponding block (block prior to moving) specified by a motion vector mv_{j, i} on a motion search reference frame j for each motion search block (S1601). In the case of S1406 in FIG. 14, j denotes i−m. By contrast, if the processing illustrated in FIG. 16 is performed at S1411 in FIG. 14, j denotes i−1.

In the example illustrated in FIG. 7, to estimate the reliability relⱼ of the motion search block P, the reliability estimating module 1305 reads the reliability relⱼ of a reliability block adjacent to the corresponding block P′ whose position is corresponding to the position of the motion search block P prior to moving from the reliability storage 1304.

Subsequently, based on the distances between the corresponding block (e.g., the corresponding block P′) whose position is corresponding to the position of the motion search block (e.g., the motion search block P) before the motion vector moves and the reliability blocks adjacent thereto, the reliability estimating module 1305 calculates the weighted average of the reliability of the reliability blocks adjacent to the corresponding block, thereby calculating the reliability of the motion search vector (motion search block P) (S1602).

The reliability estimating module 1305 averages out the reliability calculated for the motion search blocks included in the reliability block, thereby generating the reliability relᵢ of the reliability block (S1603).

In the process described above, the reliability estimating module 1305 calculates the reliability relᵢ for all the reliability blocks included in the frame image data. Subsequently, through the processing flow illustrated in FIG. 16, the reliability relᵢ of each reliability block is output.

Referring back to FIG. 14, the reliability estimating module 1305 deletes the frame image data of the frame number i−m from the frame buffer 101 (S1407).

By contrast, if the characteristic amount calculator 1301 determines that the frame number i is not a multiple of the constant m at S1403 (No at S1403), the motion search module 1302 performs motion search between the frame image data of the frame number i−1 and the frame image data of the frame number i stored in the frame buffer 101 (S1410). The process of the motion search is the same as that of S1405 except that the number of the reference frame is i−1.

The reliability estimating module 1305 then estimates the reliability relᵢ from the reliability relᵢ₋₁ stored in the reliability storage 1304 and the motion vector mv_{i-1, i} calculated at S1410 (S1411). The reliability relᵢ thus calculated is stored in the reliability storage 1304.

Subsequently, the characteristic amount calculator 1301 deletes the frame image data of the frame number i−1 from the frame buffer 101 (S1412).

After S1407 and S1412, the generator 108 generates texture image data under control based on the reliability relᵢ (S1408).

Subsequently, the blending module 110 blends the texture image data thus generated on the frame image data (S1409).

The image processing apparatuses according to the embodiments estimate the characteristic amount or the reliability by performing motion search. As a result, a signal analysis for calculating the characteristic amount need not be performed on all the frame image data, whereby it is possible to reduce the processing load. In particular, in an image processing apparatus that originally performs motion search between frames, sharing the motion search result is especially effective for reducing the processing load.

The image processing apparatuses according to the embodiments control the degree to which a texture component is added by using the reliability in the high-quality image processing on the texture image data and the like. In this case, the image processing apparatuses calculate the characteristic amount by a signal analysis every few frames, and estimate the characteristic amount or the reliability in the other frames by using a motion search result between the frames obtained separately. With this configuration, the image processing apparatuses according to the embodiments can not only reduce the whole load related to generation of the texture image data, but also make influence on the image quality small.

In the embodiments, the texture generation processing is explained as an example of the high-quality image processing. However, the technology may be applied to super-resolution processing and edge enhancement processing for increasing the sharpness, for example.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. Moreover, the apparatuses and methods described herein may be combined as appropriate without being inconsistent with the content. The accompanying claims and their equivalents are intended to cover such forms or modifications as would fall within the scope and spirit of the inventions.

The functions of the image processing apparatuses explained in the embodiments may be included in a camera, a television receiver, and the like as components. Alternatively, the functions may be realized by executing an image processing program prepared in advance in a computer, such as a personal computer and a work station.

The image processing program executed in the computer may be distributed over a network such as the Internet. Furthermore, the image processing program may be recorded in a computer-readable recording medium, such as a hard disk, a flexible disk (FD), a compact disk read-only memory (CD-ROM), a magneto-optical disk (MO), and a digital versatile disc (DVD), and executed by being read from the recording medium by the computer.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a characteristic calculator configured to calculate, in a unit of a predetermined display area, characteristic information indicating a characteristic included in the predetermined display area of first frame image information contained in moving image information;
a search module configured to search for motion of a pixel between the first frame image information and second frame image information that is contained in the moving image information and that is posterior to the first frame image information;
an estimating module configured to estimate characteristic information in the unit of the predetermined display area of the second frame image information based on the motion of the pixel searched for by the search module and the characteristic information in the unit of the predetermined display area of the first frame image information;
a generator configured to generate high-frequency image information in which a high-frequency component varies depending on the characteristic information in the unit of the predetermined display area of the second frame image information; and
a blending module configured to blend the high-frequency image information on the second frame image information.

2. The image processing apparatus of claim 1, wherein
the high-frequency component is a texture, and
the high-frequency image information is texture image information.

3. The image processing apparatus of claim 2, further comprising:
a change amount calculator configured to calculate, for each pixel included in the second frame image information, a change amount indicating a change in a pixel value in the predetermined display area including the pixel, wherein
the generator is configured to calculate a weight related to a high-frequency component for each pixel included in the second frame image information based on the change amount calculated and a random variable based on a probability distribution indicating a distribution of relative values of a change amount of each pixel included in a high-frequency component of learning image information with respect to a change amount of each pixel included in the learning image information, to weight a predetermined image pattern indicating a pattern of a change in a pixel value with the weight, and to generate the texture image information in which a high-frequency component to be added varies depending on the characteristic information.

4. The image processing apparatus of claim 1, wherein
the search module is configured to search for the motion of the pixel in a unit of a block obtained by dividing the unit of the predetermined display area in the second frame image information, and
the estimating module is configured to estimate characteristic information of the predetermined display area based on characteristic information of a block included in the first frame image information whose position is corresponding to a position prior to moving of the block obtained by dividing the predetermined display area included in the second frame image information.

5. An image processing method comprising:
calculating, by a characteristic calculator, in a unit of a predetermined display area, characteristic information indicating a characteristic included in the predetermined display area of first frame image information contained in moving image information;
searching for, by a search module, motion of a pixel between the first frame image information and second frame image information that is contained in the moving image information and that is posterior to the first frame image information;
estimating, by an estimating module, characteristic information in the unit of the predetermined display area of the second frame image information based on the motion of the pixel searched for at the searching and the characteristic information in the unit of the predetermined display area of the first frame image information;
generating, by a generator, high-frequency image information in which a high-frequency component varies depending on the characteristic information in the unit of the predetermined display area of the second frame image information; and
blending, by a blending module, the high-frequency image information on the second frame image information.

6. The image processing method of claim 5, wherein
the high-frequency component is a texture, and
the high-frequency image information is texture image information.
